(19) United States
(12) Patent Application Publication
(10) Pub. No.: US 2015/0153629 A1
(43) Pub. Date: Jun. 4, 2015

(54) OPTICAL FILTER LOCK AND ENVIRONMENTAL SEAL

(71) Applicant: MAMIYA AMERICA CORPORATION, White Plains, NY (US)

(72) Inventors: Liu Hao, Zhuhai City (CN); Lu Yi, Yorktown Heights, NY (US); Robert Michael Rose, Woodcliff Lake, NJ (US)

(21) Appl. No.: 14/554,559

(22) Filed: Nov. 26, 2014

(30) Foreign Application Priority Data
Nov. 29, 2013 (CN) 2013207757795

(51) Int. Cl. G03B 11/00

(52) U.S. Cl. CPC G03B 11/00

(57) ABSTRACT

The present invention is directed to a camera lens filter assembly including a camera lens filter and an included optical component. The optical component is installed on an optic mounting part; and a clamp is mounted on a clamp mounting part, so the clamp can press to tighten against the optical component for the purpose of assembly. The present invention efficiently prevents air, dust and other environmental pollutants from reaching the front surface of the camera lens and will also seal to secure the camera lens filter to the camera lens barrel in a way that it will not dismount itself due to vibration, use or other operating conditions.

The present invention claims priority to China Patent Application No. 201320775779.5, filed Nov. 29, 2013, which is incorporated herein by reference.

The present invention relates to photo, film and video camera equipment, and in particular an externally mounted optical filter assembly and its attachment to a camera lens.

### BACKGROUND OF THE PRESENT INVENTION

A camera lens filter is a frequently used piece of photographic equipment which is typically attached in front of a photographic lens by a screw thread to the camera lens barrel. Optical filters are mainly used for blocking unwanted radiation (i.e., ultra violet or UV), to protect the front element of a camera lens and/or to adjust the photographic effect in a way that would be difficult or impossible to do by camera controls alone. A conventional existing camera lens filter, as shown in FIG. 1, is comprised of frame 1, optical component (typically but not limited to a flat filter or thin lens) 3 and clamp 4 to secure the optical component to the frame. The sealing performance of these connected parts is poor, causing air, dust and other environmental pollutants to be able to bypass multiple connected gaps and reach the front surface of the camera lens to which it is mounted.

Another issue with present day filters is that a camera lens filter may have a tendency to self-dismount, such as through vibration or other operating conditions.

To overcome these issues, the present invention includes a plurality of seals, in further combination with an assembly structure, which together prevents air, dust and other pollutant infiltration, and also secures the camera lens filter to the camera lens barrel in a way that the filter assembly will not dismount itself due to vibration, use or other operating conditions.

### BRIEF DESCRIPTION OF THE PRESENT INVENTION

To overcome these issues, the present invention aims to provide an optical filter assembly (including at least one camera lens filter), which is capable of camera lens sealing protection, so as to effectively prevent air, dust and other pollutants from reaching the front of the camera lens. In addition, the present invention also provides a seal to secure the optical filter assembly to the camera lens barrel in such a way that the assembly also will not dismount itself due to vibration, use or other operating conditions.

In order to realize the above mentioned aim, according to an aspect of the invention, the assembly includes a kind of camera lens filter, included in a filter frame having a first end and a second end opposite the first end. The first end of the filter frame is provided with a connecting device, the inner wall of the filter frame is provided with a clamp mounting portion and an optic mounting part along the axial direction. The rear facing part of the filter assembly has a male thread that is half the connecting device—the other part being the female thread on the front of the lens barrel. Optical components, such as a filter, are installed on the optic mounting part; a clamp is mounted on the clamp mounting portion, and when manually engaged presses tightly against the optical component to secure it. As indicted above the thread on the outside of the filter frame may be the connecting device, the clamp may be the retaining ring part that presses against the filter or the sealing O-ring to lock the glass filter (or other material filter) into the filter frame. A first sealing mechanism is provided between the optical component and the optic mounting part for positively locking down the optical component. The optical mounting part may essentially be a flat surface inside the filter frame that one side of the glass filter rests against. In one embodiment, this sealing mechanism is an O-ring. A second sealing mechanism is also provided, is located on the outer wall of the filter frame, and preferably seals by pressing against and friction locking the filter assembly to the front of the camera lens barrel to which it is being mounted. In one embodiment, the sealing mechanisms may each be an O-ring. In combination, the first and second sealing mechanisms form seals to preclude dust and other materials from entering the lens area and adhering to the lens. In addition, these seals preclude undesired loosening of the filter.

In the present invention, the first sealing mechanism sits between the optical component and the optical mounting part. The second sealing mechanism sits on the outer wall of the first point of contact to the lens barrel just after the threads join the filter frame and lens barrel.

Preferably, the first sealing mechanism comprises a first sealing ring, or alternatively (or in addition), the sealing material for the first seal is formed of a glue or coating material, or a combination of a sealing ring and a glue or coating material.

Preferably, the second sealing mechanism comprises a second sealing ring, which is external and can be seen between the inside end of the male filter thread and the body of the filter ring.

To facilitate the installation of the first sealing mechanism, which is preferably a circular sealing ring with a circular or oval shape in cross-section, preferably, there is a first groove on the first surface that is opposite to the optical component, and the first sealing mechanism is mounted using the first groove.

Alternatively, the first surface is an annular surface used to support the optical component along the inner wall of the filter frame and extending axially.

Or alternatively, the first surface is the one extending axially opposite the optical component outer wall, and the first groove is an annular groove recessed outwardly from the first surface.

Similarly, in order to facilitate installation of the second sealing mechanism, especially to better position the sealing mechanism which is also preferably a sealing ring of a circular or oval shape cross-section, preferably, a second sealing mechanism mounting part is set on the outer wall of the filter frame, and the second sealing mechanism is mounted in the second groove.

For ease of processing and installation of the second sealing mechanism, preferably the second surface is an annular surface extending outwardly along with the outer of the filter frame.

According to another embodiment, the present invention provides a kind of optical assembly, including the first end connecting with the barrel of the camera lens barrel and the second end away from the camera lens. The second end of the filter frame can include a connecting device used to match with a second camera lens filter or other external accessory. The second sealing mechanism is set between the camera lens barrel and camera lens filter frame.

In conclusion, the present invention includes placing the first sealing mechanism between the camera filter lens and the inside of the filter frame and/or setting the second sealing mechanism on the outer wall of the filter frame, which is used to seal the gap between the camera lens barrel and the camera lens filter frame, so as to prevent air, dust and other pollutants from reaching the front surface of the camera lens along the connected parts of the optical component and filter frame and/or the connected parts of the camera lens barrel and filter frame, effectively providing the sealing protection for the front of the camera lens and preventing dismount of the camera lens filter itself due to vibration, use or other operating conditions.

### BRIEF DESCRIPTION OF THE DRAWINGS

Hereinafter, reference to the drawing to describe the embodiments of the utility model in detail in which:

FIG. 1 shows the sectional view and partially enlarged schematic diagram of a current typical camera lens filter along the longitudinal centerline.

FIG. 2 shows the three-dimensional schematic diagram of the camera lens filter of this utility model.

FIG. 3 shows an exploded view of the camera lens filter assembly in FIG. 2.

FIG. 4a shows the sectional view and partially enlarged schematic diagram of the camera lens filter along the longitudinal centerline in FIG. 2.

FIG. 4b shows the partially enlarged sectional view schematic of the camera lens in to which the camera lens filter FIG. 4a is installed.

FIG. 5 shows the sectional view and partially enlarged schematic diagram of the camera lens filter another practical embodiment along the longitudinal centerline.

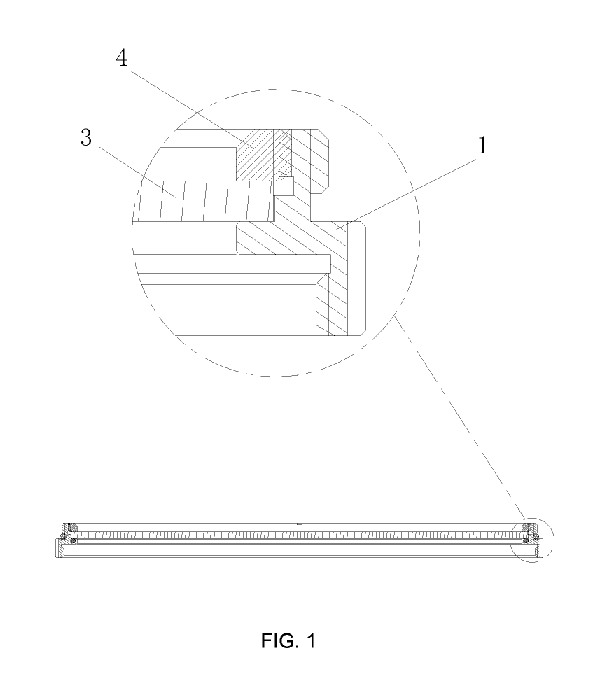

### DETAILED DESCRIPTION OF THE PRESENT INVENTION

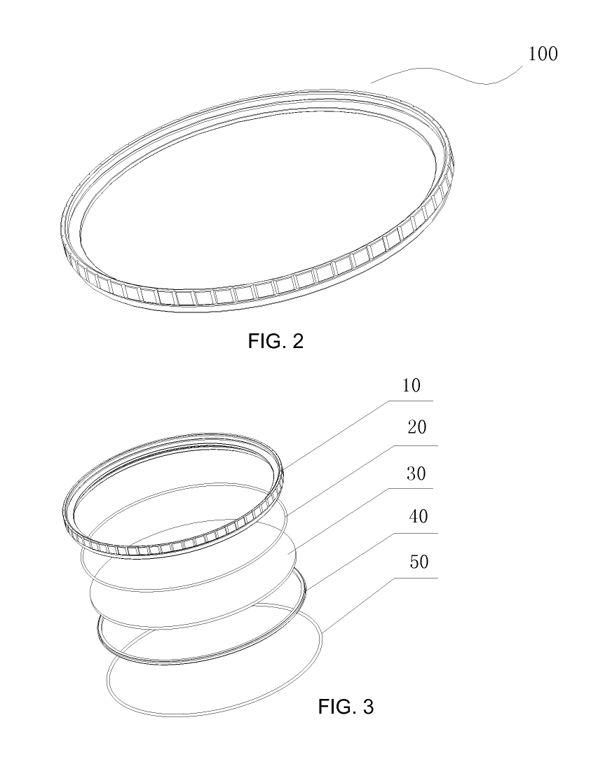

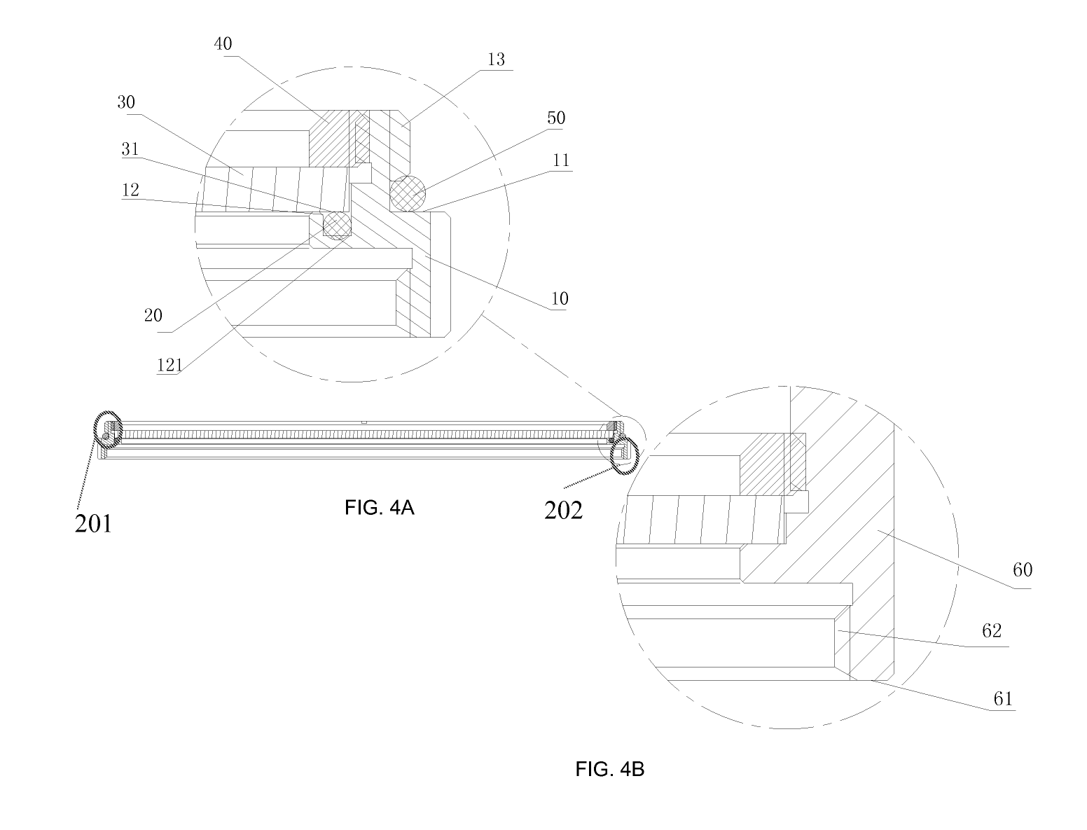

As shown in FIGS. 2-4b, the present invention provides a camera lens filter assembly 100, which provides structure and support for component parts including filter frame 10, first sealing ring 20, optical component 30, clamp 40 and second sealing ring 50. In which, as shown in FIG. 4a and FIG. 4b, the filter frame 10 includes first end 201 and second end 202 opposite the first end. The first end of filter frame 10 includes a connecting device to connect with camera lens barrel 60. The clamp mount and optic mount are set along the axial direction of the inner wall of filter frame 10, optical component 30 is mounted on an optic mount system, clamp 40 is mounted on clamp mount system, and clamp 40 can lock optical component 30. In which, the first sealing mechanism included between optical component 30 and optic mount system seals the gap between optical component 30 and filter frame 10, which can prevent air, dust and other pollutants from reaching the from surface of the camera lens. This invention also includes a second sealing mechanism that used to seal the gap between camera lens barrel 60 and filter frame 10 is set on the inner side of the connecting system of the outer wall of filter frame 10, which in addition to preventing air, dust and other pollutant infiltration will also seal to secure the camera lens filter to the camera lens barrel in a way that it will not dismount itself due to vibration, use or other operating conditions. Although described herein as a “clamp” and as a “clamp mounting system” the device is a retaining ring and merely provides a means for locking the optical element into the filter assembly in place and may be formed of a threaded retaining ring, circular spring set in a groove or some other method for securing the optical element into the filter frame assembly.

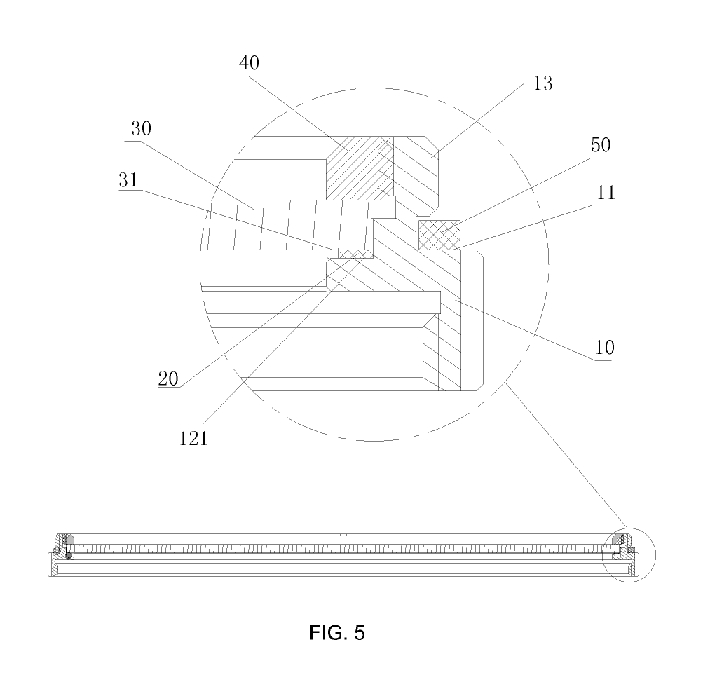

As shown in FIG. 4a and FIG. 4b, the first sealing mechanism can be first sealing ring 20, or alternatively a sealing material applied to the optical component 30 and/or to the optic mounting system, such as glue or coating material. The second sealing mechanism preferably includes the second sealing ring 50. The cross section of each of the first sealing ring 20 and the second sealing ring 50 can be preferably circular, or elliptical, as shown in FIG. 4b, or rectangular as shown in FIG. 5, or can be other shapes, as long as it provides a sealing performance between the connections.

The camera lens filter assembly 100 can prevent air, dust and other pollutants from going through the connection between optical component 30 and filter frame 10 by setting the first sealing mechanism between optical component 30 and optic mount, which effectively prevents the front surface of the camera lens from dust, dirt and damage. In addition, when camera lens filter assembly 100 is mounted on lens barrel 60, the second sealing mechanism on the outer wall of filter frame 10 in addition to preventing air, dust and other pollutant infiltration will also seal to secure the camera lens filter to the camera lens barrel in a way that it will not dismount itself due to vibration, use or other operating conditions. That is, the filter is embedded in a sealed frame and the frame is sealed to the camera barrel.

It should be understood that in the context of the present invention it is possible to individually set the sealing mechanism between optical component 30 and filter frame 10, and/or individually set the sealing mechanism between camera lens barrel 60 and filter frame 10.

In order to better fix the position of the first sealing mechanism may be fixed in position, especially when the first sealing mechanism comprises a circular shape, preferably, as shown in FIG. 4a, by positioning the first sealing ring 20 in the first groove 12 located over the first groove base surface 121 which is in the filter frame 10 optic mount part opposite optical component 30. Preferably, the first groove base surface 121 is the annular surface axially extending along the inner wall of filter frame 10 supporting optical component 30. The first groove 12 is the annular groove which extends axially from the first groove base surface 121 toward the second end of filter frame 10. It is understood that the first groove 12 can be extended axially, as it is set opposite the side wall of optical component 30, and the first groove 12 can be an annular groove extending axially from the first surface, without departing from the protective scope of this present invention.

Similarly, in order to better position the second sealing mechanism, preferably the second sealing mechanism is set on the inner side of the outer wall of filter frame 10. A second surface (or second groove) 11 of filter frame 10 the base of the second groove fit preferably by friction fit. The second sealing mechanism is installed into the second groove, typically utilizing threading. Preferably the second surface 11 is an annular surface extending along the outer wall of filter frame 10, and the second groove is an annular groove extending axially from the second surface 11 toward the second end of filter frame 10. The second surface can also extend axially along the second surface, and is opposite the inner wall of lens barrel 60. The second groove preferably is an annular groove extending axially along the second surface.

The invention also provides a kind of camera lens filter, including the first end connecting with camera lens barrel and the second end away from the camera lens.

The second end of lens barrel 60 provides a connecting system used for matching with the above mentioned connecting system of camera lens filter assembly 100; the second sealing mechanism is set between the second end of lens barrel 60 and filter frame 10. In further description, as shown in FIG. 4a and FIG. 4b, the total system includes camera lens barrel 60 and camera lens filter assembly 100, included in which is camera lens filter assembly 100, including filter frame 10, optical component 30, clamp 40, the first sealing ring 20 and the second sealing ring 50. The second sealing ring 50 is mounted on the second surface 11 of filter frame 10, and the first sealing ring 20 is mounted on the first groove 12 of filter frame 10. When optical component 30 is installed into filter frame 10, clamp 40 is used to lock optical component 30. The lower surface of the first sealing ring 20 as show in FIG. 4a is in contact with the first groove base surface 121 of filter frame 10. The upper surface of the first sealing ring 20 is in contact with the lower surface 31 of optical component 30, so as to close the connection gap between optical component 30 and filter frame 10, which can prevent air, dust and other pollutants from entering into the space around optical component 30. When optical component 30, the filter frame 10, clamp 40 and the first sealing ring 20 are assembled as a whole, the basic camera lens filter assembly 100 is finished.

When mounting camera filter assembly 100 onto lens barrel 60, the camera filter assembly 100 is joined by male thread screw 13 and female thread screw 62 as shown in FIG. 4b. The front 61 of lens barrel 60 compresses the second sealing ring 50 as shown in FIG. 4a. The lower surface of the second sealing ring 50 closes the gap between the second groove 11 of the filter frame 10, which in addition to preventing air and dust infiltration also seals to secure the camera lens filter to the camera lens in a way that it will not dismount itself due to vibration, use or other operating conditions.

As with the other embodiments of the utility model, as shown in FIG. 5, the first sealing ring 20 and the second sealing ring 50 can respectively be alternatively shaped, such as in the form of a rectangular spacer, which can also achieve the same sealing function. Also, as an alternative to a sealing ring, the first sealing mechanism can be a glue or paint sealant applied on optical component 30 and/or filter frame 10, which can seal the connection gap between optical component 30 and filter frame 10 to prevent air, dust and other pollutants from reaching the front surface of the camera lens. In summary, the camera lens filter assembly 100 can prevent air, dust and other pollutants from reaching the front surface of the camera lens via the connection between optical component 30 and filter frame 10 by setting the first sealing mechanism between optical component 30 and optic mount system, which effectively protects the camera lens from dirt, dust, other pollutants and damage. In addition, when camera lens filter 100 is mounted on lens barrel 60, the second sealing mechanism on the outer wall of filter frame 10 effectively prevents air, dust and other pollutant infiltration and will also seal to secure the camera lens filter to the camera lens barrel in a way that it will not dismount itself due to vibration, use or other operating conditions.

Many modifications and other embodiments of the present disclosure will come to mind to one skilled in the art to which the present disclosure pertains having the benefit of the teachings presented in the foregoing description; and it will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A camera lens filter comprising:
a filter frame having a first end and a second end opposite said first end, said first end provided with a connecting system comprising a clamp mount part and optic mount part, each extending axially from said first end;
an optical component mounted on said optic mounting part; and
a clamp mounted on said clamp mounting part, with said clamp applying pressure when tightened against the optical component to secure it;
wherein a first sealing mechanism is between said optical component and said optic mounting part, and said second sealing mechanism is set on the outer wall of said filter frame.

2. The camera lens filter of claim 1, wherein said first sealing mechanism comprises at least one of said first sealing ring and a sealing material applied on said optical component or said optic mounting part.

3. The camera lens filter of claim 2, wherein said sealing material is a glue or paint.

4. The camera lens filter of claim 1, wherein said second sealing mechanism comprises a second sealing ring.

5. The camera lens filter of claim 1, wherein a groove of said filter frame is set on a first surface opposite said optical component and said first sealing mechanism is installed into said groove.

6. The camera lens filter of claim 5, wherein said first surface is an annular surface extending axially from an inner wall of said filter frame to support said optical component.

7. The camera lens filter of claim 5, wherein said first surface is opposite an outer wall of lens and extends axially, and said groove is an annular groove that said first surface outwardly extends from.

8. The camera lens filter of claim 1, wherein a second sealing mechanism mount part is set on an outer wall of said filter frame, a second groove is set on a second surface, and said second sealing mechanism is installed into said second groove.

9. The camera lens filter of claim 8, wherein said second surface is annular and extends outwardly along said outer wall.
